(19) United States
(12) Patent Application Publication
(10) Pub. No.: US 2007/0217208 A1
(43) Pub. Date: Sep. 20, 2007

(54) PROTECTIVE GUARD FOR A LIGHT FIXTURE

(76) Inventor: Gary D. Yurich, Royal Oak, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/276,884

(22) Filed: Mar. 17, 2006

(51) Int. Cl. F21V 15/00

(52) U.S. Cl. 362/376; 362/186; 362/352

(57) ABSTRACT

A protective guard (10) protects a light fixture (12) disposed therein from projectiles. The protective guard (10) comprises a flexible netting (14), an upper support (16) and a lower support (18) that bias the flexible netting (14) outwardly to define an opening (26) for receiving the light fixture (12). The flexible netting (14) has a top edge (20), a bottom edge (22), and at least one side (24) extending therebetween. The upper support (16) is adjacent the top edge (20) and the lower support (18) is adjacent the bottom edge (22). At least one additional support (28) is disposed between and is substantially parallel to the upper and lower supports (16, 18). The additional support (28) stretches the flexible netting (14) taught between the upper and lower supports (16, 18) for absorbing a force from a projectile and for preventing contact between the projectile and the light fixture (12).

### BACKGROUND OF THE INVENTION

1. Field of the Invention

The subject invention relates to a protective guard for protecting a light fixture disposed therein from projectiles, and more specifically, the protective guard absorbs forces from the projectile without damaging the light fixture and prevents the projectile from ricocheting.

2. Description of the Related Art

Various light fixtures are used in certain environments, such as driving ranges, batting cages, indoor baseball, football, lacrosse, field hockey, and sports arenas and complexes, that require additional protection. These light fixtures are subject to being struck by flying projectiles and being damaged as a result of being struck. Some light fixtures have included a metal screen positioned directly in front of a light bulb of the light fixture. One disadvantage of these metal screens or light fixtures generally is that the projectile will ricochet and potentially cause additional damage or injury after bouncing off the screen or fixture. However, when struck by the projectile with enough force, the metal screen bends and strikes the light fixture with sufficient strength to damage the light fixture. Other projectiles, such as golf balls, may be small enough to pass through the screen. Further, the force or impact of the projectiles alone may be sufficient to damage the light fixture.

Since these light fixtures are breakable, many environments can only light from outside of the playing area resulting in darkened environments that are less appealing to users because the environments are poorly lit. In addition, the light fixtures have been suspended farther away such that the projectiles cannot reach the light fixture. Again, this solution is inadequate because the environment is poorly lit.

### SUMMARY OF THE INVENTION

The subject invention provides a protective guard, or cage, for protecting a light fixture disposed therein from projectiles. The protective guard comprises a flexible netting, an upper support, and a lower support. The flexible netting has a top edge and a bottom edge and at least one side extending therebetween. The upper support is adjacent the top edge and the lower support is adjacent the bottom edge. The upper and lower supports bias the flexible netting outwardly to define an opening for receiving the light fixture. At least one additional support is disposed between and is substantially parallel to the upper and lower supports. The additional support stretches the flexible netting taught between the upper support and the additional support and the lower support and the additional support for absorbing a force from a projectile to prevent contact between the projectile and the light fixture and to keep the projectile from ricocheting off from the guard.

The subject invention overcomes the inadequacies that characterize the related art. Specifically, the protective guard protects the light fixture in such a manner that the light fixture may be located in the path of the projectiles with reduced or eliminated damage when struck. In other words, the light fixtures may be positioned within the playing area thereby improving the lighting therein. Since the light fixture will undergo reduced or eliminated damage, more light fixtures may be located in desirable locations to provide more light to the specific environments. Further, these environments are able to include more light assemblies within the playing space comprising the protective guard and light fixture since the light fixtures are less likely to be damaged when the protective guard absorbs and dissipates the forces from the flying projectiles. The protective guard reduces the ricochet of the projectile as a result of absorbing the forces from the projectile.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a side view of a protective guard having a light fixture disposed therein;

FIG. 2 is a close-up view of a sleeve holding an additional support and sewn to a flexible netting;

FIG. 3 is a bottom view of the protective guard;

FIG. 4 is a top view of the protective guard; and

FIG. 5 is a close-up view of a cable having a loop for suspending the protective guard about the light fixture.

### DETAILED DESCRIPTION OF THE INVENTION

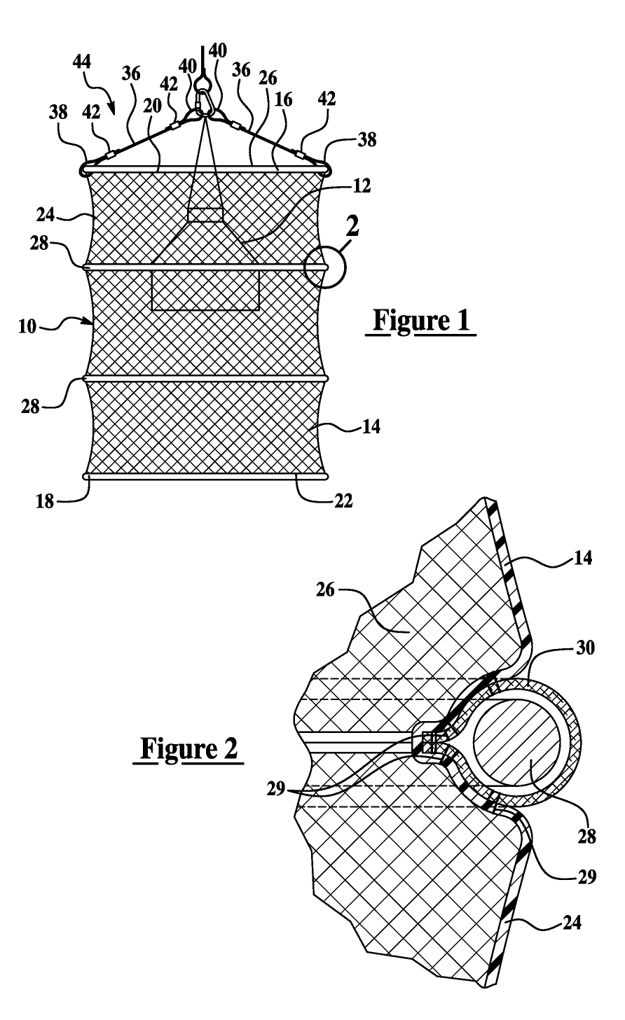

Referring to the Figures, wherein like numerals indicate corresponding parts throughout the several views, a protective guard for protecting a light fixture 12 disposed therein from projectiles (not shown) is shown generally at 10 in FIG. 1. In certain environments, such as driving ranges, batting cages, indoor baseball, football, lacrosse, field hockey, and sports arenas and complexes, the light fixtures 12 are subject to being struck by flying projectiles. One solution has been to light the playing area from outside the playing area and/or reduce the number of light fixtures 12 that are present in the playing area. However, the environments are then poorly lit making it difficult for users. For example, users have difficult times locating their balls in golf driving ranges that extend for a couple hundred yards and only have a few light fixtures 12. In addition to protecting light fixtures 12, the subject invention may also protect other breakable fixtures common to these environments, such as speakers and the like.

The protective guard 10 generally comprises a flexible netting 14, an upper support 16, and a lower support 18. The flexible netting 14 has a top edge 20 and a bottom edge 22 and at least one side 24 extending therebetween. The flexible netting 14 is a light-weight material. Preferably, the flexible netting 14 is a fabric material, such as nylon or the like. The flexible netting 14 is flexible such that various shapes can be formed from the flexible netting 14 as understood by those of ordinary skill in the art.

The upper support 16 is adjacent the top edge 20 and the lower support 18 is adjacent the bottom edge 22. The upper and lower supports 16, 18 bias the flexible netting 14 outwardly to define an opening 26 for receiving the light fixture 12. In other words, the upper and lower supports 16, 18 stretch out the flexible netting 14 at the top and bottom edges 20, 22, respectively, and the light fixture 12 is inside the flexible netting 14. It is desirable that the upper and lower supports 16, 18 have a circumference greater than a circumference of the flexible netting 14 to sufficiently stretch the flexible netting 14. However, it is to be appreciated that upper and lower supports 16, 18 may have a circumference of the same or less than the flexible netting 14 and still sufficiently stretch the flexible netting 14 to absorb forces from projectiles.

The upper and lower supports 16, 18 may be formed from any rigid material. Preferably, the upper and lower supports 16, 18 are metal rods having a geometrical shape of one of circular, elliptical, triangular, pentagonal, or rectangular. Since the flexible netting 14 is flexible, the shape of the upper and lower supports 16, 18 contributes to the overall shape of the protective guard 10. More preferably, the metal rods are steel and the most preferably, the metal rods are circular.

The protective guard 10 also includes at least one additional support 28 disposed between and substantially parallel to the upper and lower supports 16, 18. The additional support 28 stretches the flexible netting 14 taught between the upper support 16 and the additional support 28 and the lower support 18 and the additional support 28. Once the flexible netting 14 is taught, the protective guard 10 is able to absorb forces from projectiles and prevents contact between the projectile and the light fixture 12. Similarly to the upper and lower supports 16, 18, the additional support 28 may have a circumference greater than a circumference of the flexible netting 14 in order to sufficiently stretch the flexible netting 14.

In order to secure the upper, lower, and additional supports 16, 18, 28 to the flexible netting 14, a plurality of sleeves 30 are supported by the flexible netting 14 and are shown in FIG. 2. The sleeves 30 receive the upper, lower, and additional supports 16, 18, 28. The sleeves 30 may extend continuously for the length of the supports 16, 18, 28 or may be a loop disposed at discrete locations about the flexible netting 14. The sleeves 30 may be formed of various materials, but are preferably formed from a light-weight fabric material. The sleeves 30 may also be sewn to the flexible netting 14 to adequately secure the upper, lower, and additional supports 16, 18, 28 to the flexible netting 14. The sleeves 30 may be sewn on an inside or an outside of the flexible netting 14, depending upon the type of upper, lower, and additional supports 16, 18, 28 that are utilized. The sleeve 30 shown in FIG. 2 is sewn (as shown at 29) to an exterior of the flexible netting 14.

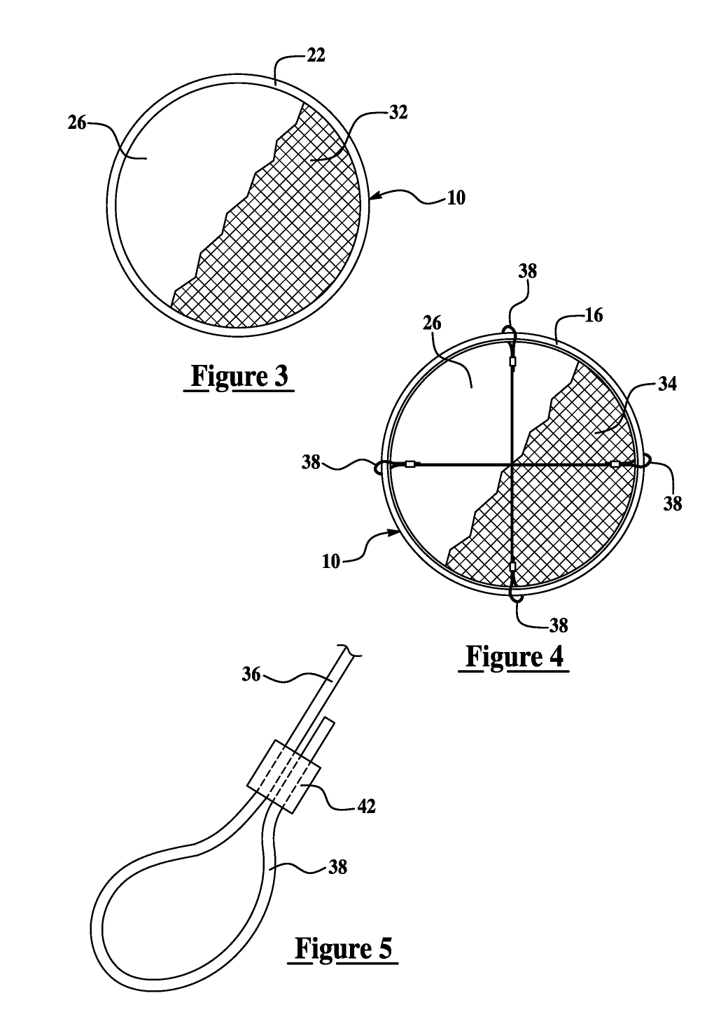

Referring to FIG. 3, the protective guard 10 may also comprise a bottom netting 32 supported by the lower support 18 and enclosing the bottom edge 22 for preventing projectiles from entering the opening 26. For example, the bottom netting 32 may be sewn to the sleeve 30 holding the lower support 18. With reference to FIG. 4, a top netting 34 may also be supported by the upper support 16 to enclose the top edge 20 for preventing projectiles from entering the opening 26. As one example, the top netting 34 may be sewn to the sleeve 30 holding the upper support 16.

In order to suspend the protective guard 10 about the light fixture 12, cables 36 may be used and are best shown in FIG. 1. The cables 36 attach to the upper support 16 and to the light fixture 12. Typically, the light fixture 12 is suspended from a ceiling by a chain, a cable, a rod, or the like. The cable 36 preferably connects to the chain and the upper support 16 such that the light fixture 12 is centrally disposed within the flexible netting 14. The cables 36 comprise an upper loop 38 on one end for engaging the upper support 16 and a fixture loop 40 on the other end for engaging the light fixture 12. Referring now to FIG. 5, the loops 38, 40 are formed from a clamp 42 engaging the cable 36 on the respective ends. Preferably, the loops 40 are connected via a generally C-shaped link, such as a quick link or carbineer. The c-shaped link may also be used to connect the light fixture to the chain.

The subject invention is particularly useful when used as a light assembly 44 comprising the light fixture 12 and the protective guard 10 described above. The light assembly 44 may be disposed in any of the various environments, such as driving ranges, batting cages, indoor baseball, football, lacrosse, field hockey, and sports arenas and complexes. The environments are able to include more light assemblies 44 thereby providing more light for the users. When projectiles strike the protective guard 10, the forces are absorbed by the supports 16, 18, 28 and the flexible netting 14 in such a manner that the light fixtures 12 are not damaged. For example, the addition of more light assemblies 44 to a golf driving range that is a couple hundred yards in length provides enough light that the user are able to see their balls when hit. Another advantage of the subject invention is that the facility can also be used for other events that require additional light, such as soccer, because the light fixtures can be disposed within the playing area.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A protective guard (10) for protecting a light fixture (12) disposed therein from projectiles, said protective guard (10) comprising:
a flexible netting (14) having a top edge (20) and a bottom edge (22) and at least one side (24) extending therebetween;
an upper support (16) adjacent said top edge (20);
a lower support (18) adjacent said bottom edge (22);
said upper and lower supports (16, 18) biasing said flexible netting (14) outwardly to define an opening (26) for receiving a light fixture (12); and
at least one additional support (28) disposed between and substantially parallel to said upper and lower supports (16, 18) such that said flexible netting (14) is taught between said upper support (16) and said additional support (28) and said lower support (18) and said additional support (28) for absorbing a force from a projectile and for preventing contact between the projectile and the light fixture (12).

2. A protective guard as set forth in claim 1 wherein said additional support (28) is further defined as having a circumference greater than a circumference of said flexible netting (14).

3. A protective guard as set forth in claim 2 wherein said upper and lower supports (16, 18) are further defined as having a circumference greater than a circumference of said flexible netting (14).

4. A protective guard as set forth in claim 1 further comprising a plurality of sleeves (30) supported by said flexible netting (14) for receiving said upper, lower, and additional supports (16, 18, 28).

5. A protective guard as set forth in claim 4 wherein said plurality of sleeves (30) are further defined as sewn to said flexible netting (14).

6. A protective guard as set forth in claim 5 wherein said sleeves (30) are sewn on an inside of said flexible netting (14).

7. A protective guard as set forth in claim 5 wherein said sleeves (30) are sewn on an outside of said flexible netting (14).

8. A protective guard as set forth in claim 1 further comprising a bottom netting (32) supported by said lower support (18) and enclosing said bottom edge (22) for preventing projectiles from entering said opening (26).

9. A protective guard as set forth in claim 1 further comprising a top netting (34) supported by said upper support (16) enclosing said top edge (20) for preventing projectiles from entering said opening (26).

10. A protective guard as set forth in claim 9 further comprising cables (36) suspending said flexible netting (14) and said upper, lower, and additional supports (16, 18, 28) relative to the light fixture (12).

11. A protective guard as set forth in claim 10 wherein said cables (36) further comprise an upper loop (38) for engaging said upper support (16) and a fixture loop (40) for engaging the light fixture (12).

12. A protective guard as set forth in claim 11 wherein said upper and fixture loops (38, 40) are further defined as each having a clamp (42) for forming said respective loop.

13. A protective guard as set forth in claim 1 wherein said upper, lower, and additional supports (16, 18, 28) are further defined as having a geometrical shape of one of circular, elliptical, triangular, pentagonal, or rectangular.

14. A light assembly (44) comprising:
a light fixture (12); and
a protective guard (10) protecting said light fixture (12), said protective guard (10) comprising;
a flexible netting (14) having a top edge (20) and a bottom edge (22) and at least one side (24) extending therebetween,
an upper support (16) adjacent said top edge (20),
a lower support (18) adjacent said bottom edge (22),
said upper and lower supports (16, 18) biasing said flexible netting (14) outwardly to define an opening (26) for receiving said light fixture (12), and
at least one additional support (28) disposed between and substantially parallel to said upper and lower supports (16, 18) such that said flexible netting (14) is taught between said upper support (16) and said additional support (28) and said lower support (18) and said additional support (28) for absorbing a force from a projectile and for preventing contact between the projectile and the light fixture (12).

15. A light assembly as set forth in claim 14 wherein said additional support (28) is further defined as having a circumference greater than a circumference of said flexible netting (14).

16. A light assembly as set forth in claim 15 wherein said upper and lower supports (16, 18) are further defined as having a circumference greater than a circumference of said flexible netting (14).

17. A light assembly as set forth in claim 14 further comprising a plurality of sleeves (30) supported by said flexible netting (14) for receiving said upper, lower, and additional supports (16, 18, 28).

18. A light assembly as set forth in claim 14 further comprising cables (36) suspending said flexible netting (14) and said upper, lower, and additional supports (16, 18, 28) relative to said light fixture (12).

19. A light assembly as set forth in claim 18 wherein said cables (36) further comprise an upper loop (38) for engaging said upper support (16) and a fixture loop (40) for engaging said light fixture (12).
